(19) United States
(12) Patent Application Publication
(10) Pub. No.: US 2004/0194205 A1
(43) Pub. Date: Oct. 7, 2004

(54) Foot bath

(75) Inventor: Anthony Kit Lun Leung, North Point (HK)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(73) Assignee: CONAIR CORPORATION

(21) Appl. No.: 10/737,194

(22) Filed: Dec. 16, 2003

Related U.S. Application Data
(60) Provisional application No. 60/433,283, filed on Dec. 16, 2002.

(51) Int. Cl. E03C 1/00; A47K 3/022; A61H 35/00

(52) U.S. Cl. 4/622

(57) ABSTRACT

A portable foot bath has a reservoir for holding a volume of liquid. The reservoir has a floor. The foot bath also has a jet connected to a pump. A first outlet is in a first location of the floor and a second outlet is in a second location of the floor that is a location different than the first location. The jet circulates the liquid in the reservoir. The liquid goes through the first outlet and the second outlet to create a first whirling flow pattern and a second whirling flow pattern, respectively, from the liquid in the reservoir.

### CROSS-REFERENCE TO RELATED APPLICATIONS

This application claims priority to U.S. Provisional Patent Application Serial No. 60/433,283 filed on Dec. 16, 2002 and U.S. patent application Ser. No. 10/167,027 filed on Jun. 11, 2002.

### BACKGROUND OF THE INVENTION

1. Field of the Invention

The present invention relates to a foot bath. More particularly, the present invention relates to a portable foot bath with a reservoir having a number of adjustable jets on a floor of the reservoir.

2. Description of the Related Art

Foot therapy, Jacuzzi, and bath devices are known in the art. A number of such devices are capable of massaging the feet with heat, vibration, brushes, scrubbing devices or resilient members disposed on a bottom of a reservoir.

The prior art foot therapy devices may also provide a variety of massage sensations. These massage sensations include passing air bubbles across a surface of a user's feet in the foot therapy device, either alone or in combination with heat sensations, vibration sensations, and scrubbing sensations.

Generally, an objective in the prior art foot therapy devices is that the user initially places his or her feet in a basin or a reservoir of the foot therapy device. Thereafter, the user activates the foot therapy device to actuate the heat, the vibrations, and/or the scrubbing devices to provide soothing and relaxing therapy to the feet by increasing blood circulation in the feet. Depending upon the temperature of the liquid placed in the foot therapy device and the contents of the liquid in the foot therapy device, the foot therapy device may soften the skin, and relax muscles and joints.

However, the prior art foot therapy devices are limited in their operation. The prior art foot therapy devices pay little, if any, attention to the fluid flow patterns in the reservoir. This continuous and random movement or chaotic shaking is distracting to the user. This chaotic shaking is caused predominately by the air bubbles and the vibration.

A vibrating device will cause the fluid disposed in the reservoir to flow in a turbulent manner. This turbulent flow pattern is distracting and aesthetically displeasing to the user, especially in the instance where the user initially places his or her feet in the reservoir.

The turbulent flow pattern produced by the prior art may further cause the fluid in the reservoir to splash out of the reservoir and on to the floor. These turbulent flow patterns are generally uninviting and undesirable as they are distracting to the user. Accordingly, there is a need for a foot bath that eliminates one or more of the aforementioned drawbacks and deficiencies of the prior art.

### SUMMARY OF THE INVENTION

It is an object of the present invention to provide a foot bath that creates a first whirling flow pattern and a second whirling flow pattern from a liquid in a reservoir.

It is another object of the present invention to provide a foot bath that creates a relaxing flow pattern that is aesthetically pleasing to a user and relaxes the user.

It is still another object of the present invention to provide a foot bath that does not shake chaotically and does not create any turbulent fluid flow pattern.

It is yet another object of the present invention to provide a foot bath with a reservoir that creates a laminar fluid flow in a predetermined whirling flow pattern in the reservoir.

It is still yet another object of the present invention to provide a foot bath that has a first outlet and a second outlet in a floor of the reservoir that communicates with a pump in the foot bath.

It is a further object of the present invention to provide a foot bath that has a number of adjustable jets disposed through the floor that communicate with the pump.

It is still a further object of the present invention to provide a foot bath that has an adjustable jet that sprays fluid in a horizontal manner, that can be adjusted to spray upwardly from the horizontal manner, and that can be further adjusted to spray downwardly from the horizontal manner.

These and other objects and advantages of the present invention are achieved by a portable foot bath of the present invention. The portable foot bath has a reservoir for holding a volume of liquid. The reservoir has a diameter, a wall, and a floor. The foot bath has a jet disposed on the floor with the jet being connected to a pump. The foot bath has a first outlet in a first location of the floor and a second outlet in a second location of the floor. The second location is in a different location than the first location. The jet circulates the liquid in the reservoir. The liquid escapes through the first and second outlets to create a first and second whirling flow patterns from the liquid in the reservoir.

### DESCRIPTION OF THE DRAWINGS

FIG. 1 is a perspective view of a preferred embodiment of the foot bath according to the present invention;

FIG. 2 is a perspective view of the foot bath of FIG. 1 with a lid;

FIG. 3 is a an alternative embodiment of the foot bath of FIG. 2;

FIG. 4 is an enlarged top view of a first footrest and a second footrest of the foot bath of FIG. 3;

FIG. 5 is a perspective view of an interior portion of the foot bath of FIG. 4 showing an aeration portion of the foot bath;

FIG. 6 is an enlarged top perspective view of the aeration device of FIG. 5;

FIG. 7 is a perspective view of a portion of a reservoir of the foot bath of FIG. 2 showing a number of adjustable jets;

FIG. 8 is a perspective view of an adjustable jet of FIG. 7;

FIG. 9 is an enlarged perspective view of a section of the interior of the foot bath of FIG. 8 where the adjustable jet is connected to a tube;

FIG. 10 is another perspective view of the interior of the foot bath of FIG. 9;

FIG. 11 is another top view of the foot bath of FIG. 2 showing a first drain and a second drain;

FIG. 12 is an enlarged top perspective view of the second drain of FIG. 11;

FIG. 13 is another interior view of the foot bath of FIG. 2;

FIG. 14 is a perspective view of the foot bath of FIG. 1 showing a first whirling flow pattern and a second whirling flow pattern;

FIG. 15 is a top view of the foot bath of FIG. 2;

FIG. 16 is still another interior view of the foot bath of FIG. 15;

FIG. 17 is an enlarged perspective view of a heater of FIG. 16; and

FIG. 18 is a bottom view of the foot bath of FIG. 2.

### DETAILED DESCRIPTION OF THE INVENTION

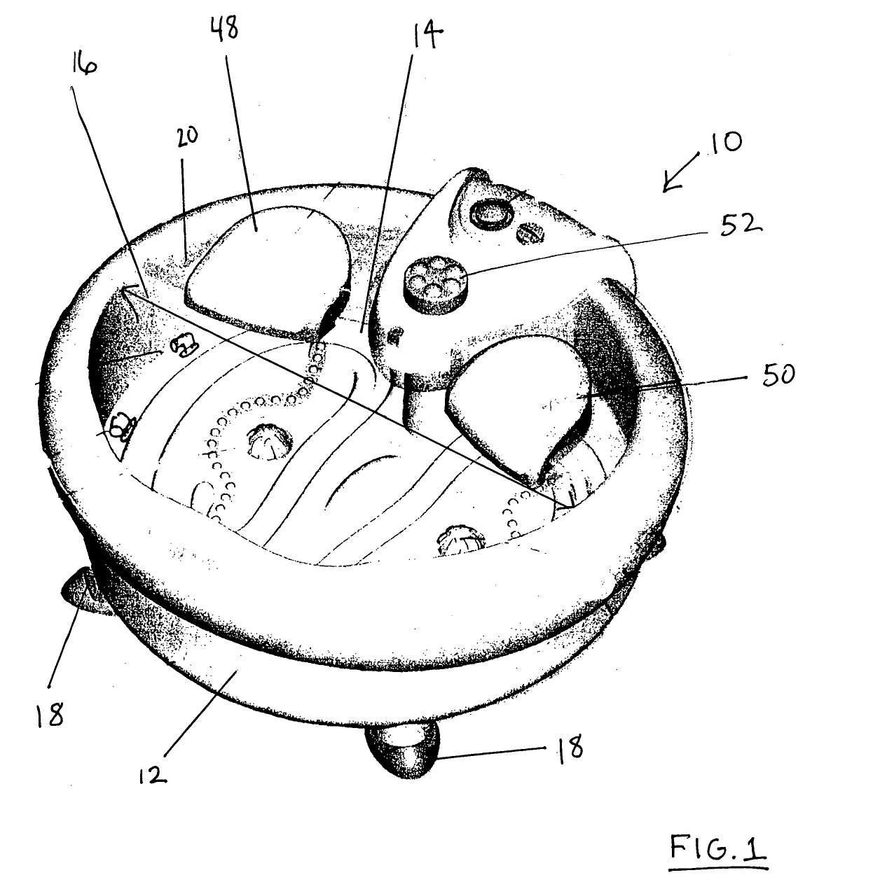

Referring to FIG. 1, there is provided a foot bath of the present invention generally represented by reference numeral 10. The foot bath 10 preferably is supported on a floor or a similar flat surface for treating, massaging and softening a user's feet. The foot bath 10 preferably imparts a relaxing massage to the user's feet by circulating water in a first and second whirling flow patterns around each foot in the foot bath. This overcomes deficiencies of the prior art foot baths with chaotic, violent, agitated and turbulent flow.

The foot bath 10 has a housing 12 that forms a reservoir 14. Preferably, the housing 12 is made from a resilient and durable material such as a thermoplastic, a thermoset, a metal, a composite, or any combinations thereof.

The reservoir 14 is preferably a receptacle or chamber for storing a fluid, such as water or a water based mixture that has soap or skin softeners, disposed therein. Preferably, the reservoir 14 is generally circular in shape and has a suitable diameter 16 so that a pair of feet can be easily and comfortably positioned in the reservoir. Further, the housing 12 has a number of legs 18. Each leg 18 is a disk shaped member. The legs 18 support the foot bath 10 on the floor or the ground for operation thereon.

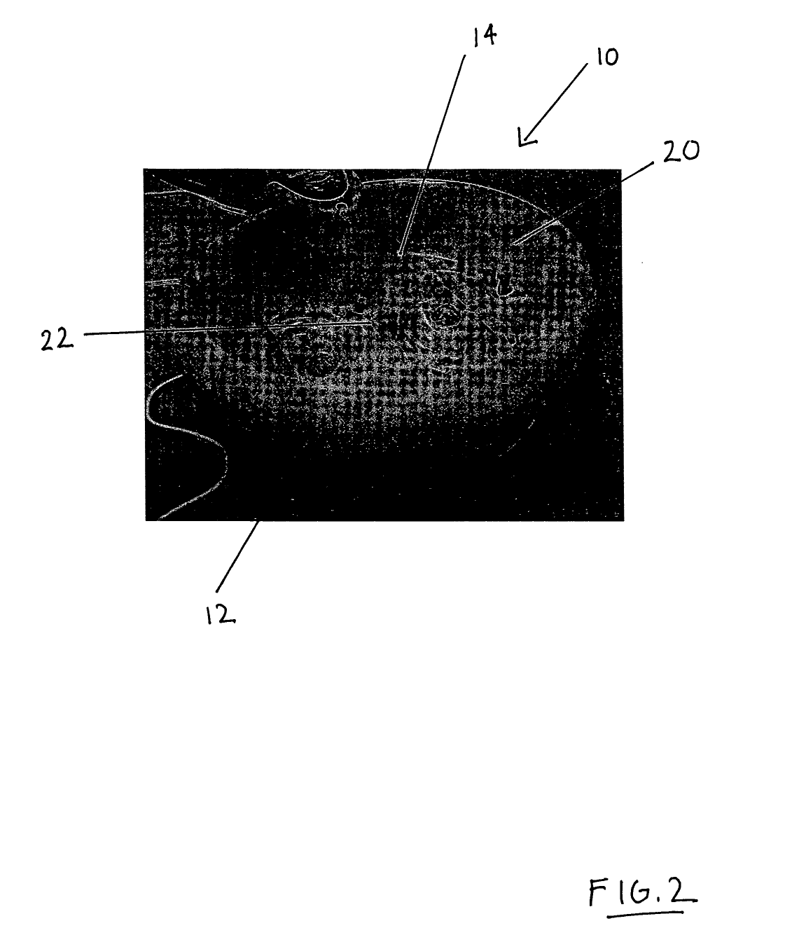

Referring to FIG. 2, the reservoir 14 of the housing 12 has an inner wall 20 and a bottom floor 22. The reservoir 14 retains the water. The inner wall 20 extends substantially perpendicular from a bottom floor 22. The inner wall 20 has a height such that a volume of water can be disposed in the reservoir 14 to preferably substantially entirely cover the user's feet, and more preferably up to a user's ankles to maximize foot therapy.

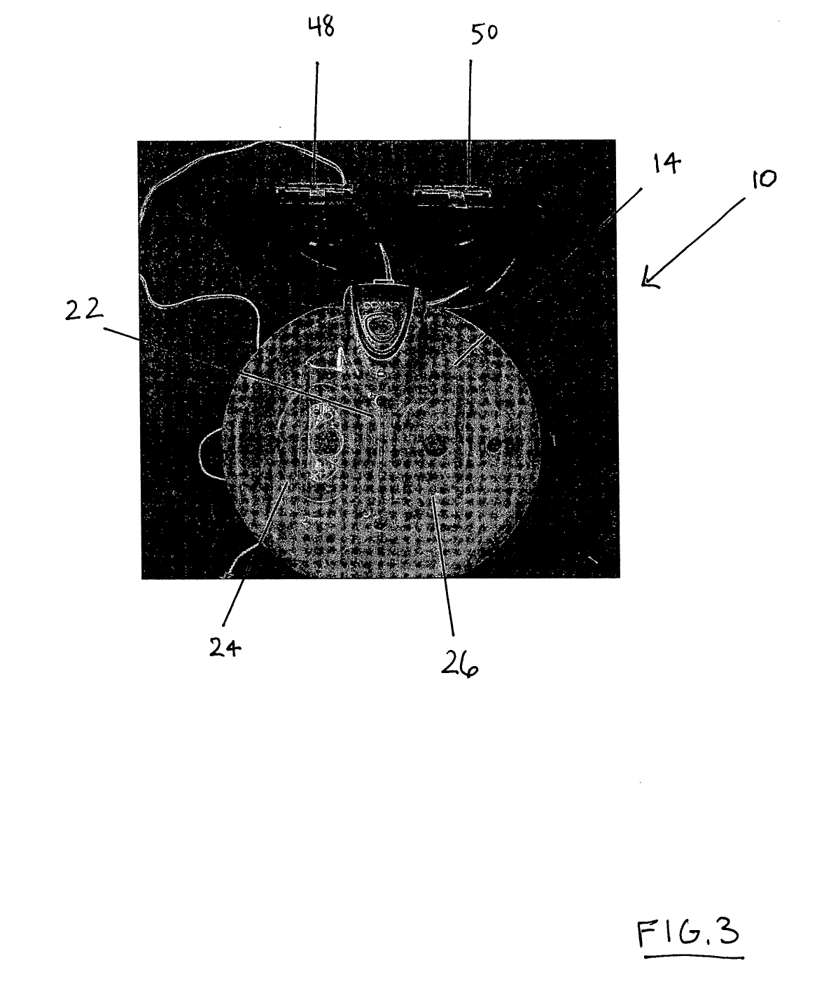

Referring to FIG. 3, the reservoir 14 has a first foot rest 24 and a second foot rest 26. Both the first foot rest 24 and the second foot rest 26 are positioned on the bottom floor 22 of the reservoir 14. The first foot rest 24 and the second foot rest 26 are both preferably a support structure in which the user's feet can comfortably rest. Preferably, the first foot rest 24 and the second foot rest 26 are a number of raised grooves disposed on or in the bottom floor 22 of the foot bath 10.

Alternatively, the first foot rest 24 and the second foot rest 26 could also be foot shaped indentations disposed above, on, or in the bottom floor 22 to comfortably rest the user's feet while engaging in the desired foot therapy. One skilled in the art should appreciate that the first foot rest 24 and the second foot rest 26 are comfortable and designed so that the user's feet may be disposed thereon for an extended period of time.

Additionally, the first foot rest 24 and the second foot rest 26 preferably both provide a tactile feedback as to a correct orientation of the user's respective left and right foot in the reservoir 14 of the foot bath 10. One skilled in the art should appreciate that the first foot rest 24 and the second foot rest 26 can have lines, grooves, protrusions or demarcations. Alternatively, a pad can be connected on the bottom floor 22 of the reservoir 14 that is comfortable when the user's feet is disposed thereon for an extended period of time.

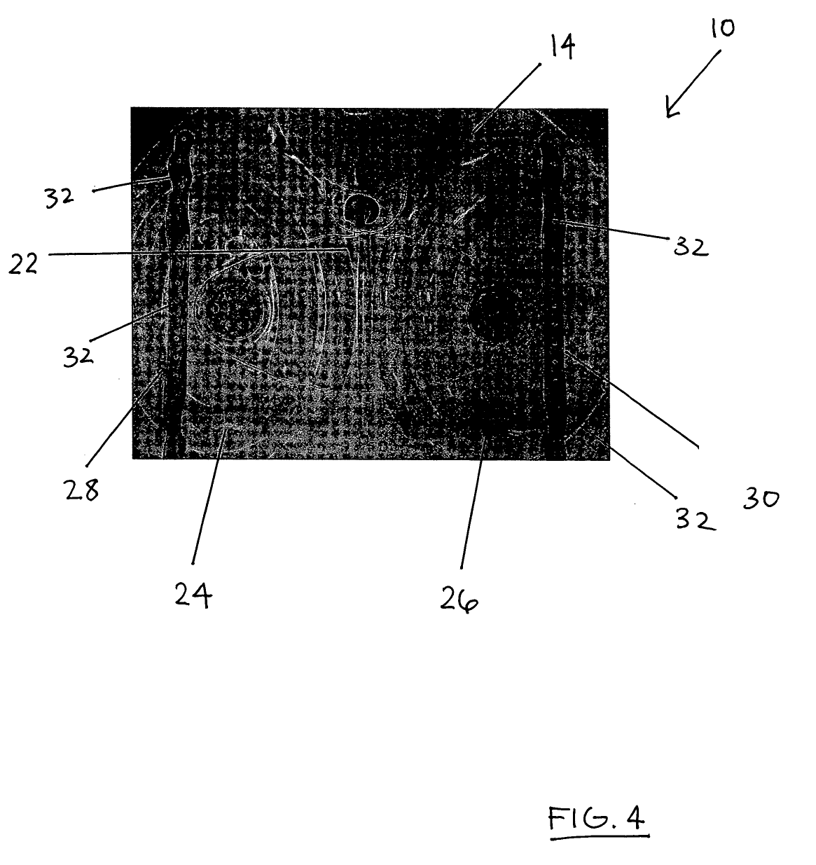

Referring to FIG. 4, there is shown a close up or exploded view of the first foot rest 24 and the second foot rest 26 of the foot bath 10. The first foot rest 24 has a first aeration tube 28 disposed thereon, and the second foot rest 26 has a second aeration tube 30 disposed thereon. Each of the first aeration tube 28 and the second aeration tube 30 have a number of apertures 32 disposed therein. One skilled in the art should appreciate that each of the first aeration tube 28 and the second aeration tube 30 may have any shape known in the art and have any number of apertures thereon.

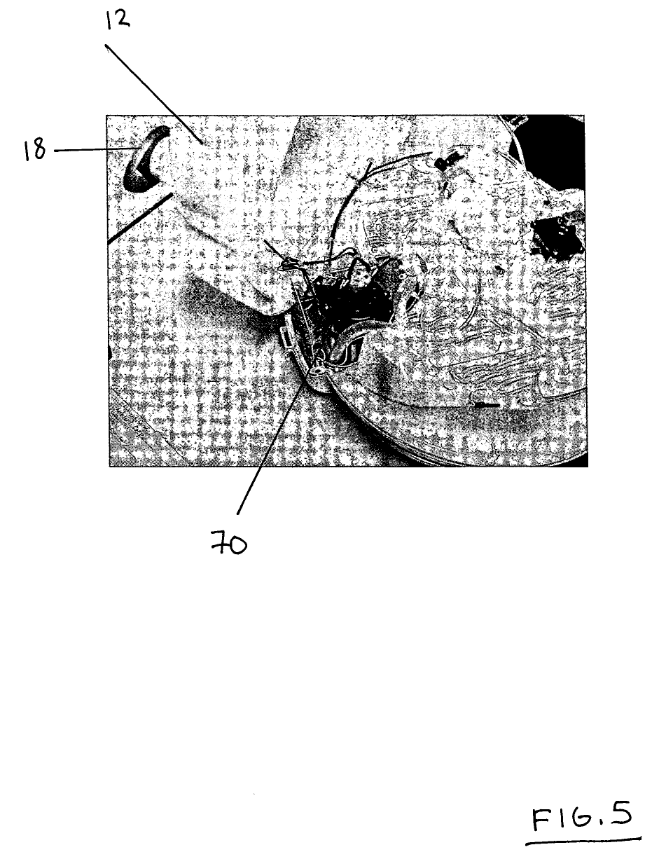

Referring to FIG. 5, beneath the bottom floor 22, the first aeration tube 28, and the second aeration tube 30, there is shown a number of internal components of the foot bath 10 of the present invention. Preferably, the first aeration tube 28 and the second aeration tube 30 are both connected through the bottom floor 22 to an aeration device 70 in the housing 12 in the interior of the foot bath 10.

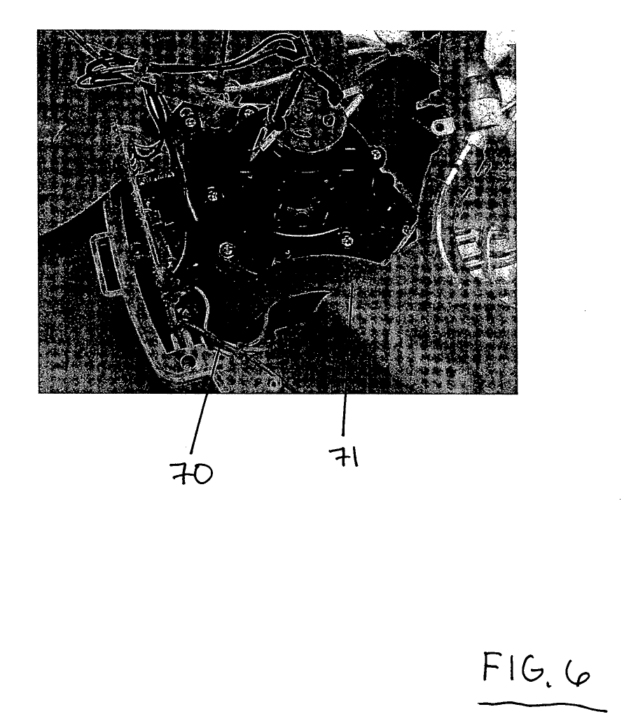

The aeration device 70 is preferably a suitable air pump. However, the aeration device 70 may be any suitable device that forces fresh air over time through the number of apertures 32 to massage and contact the user's feet. Referring to FIG. 6, the aeration device 70 is preferably connected to the first aeration tube 28 and the second aeration tube 30 by suitable tubing 71. The aeration device 70 releases an amount of fresh air through the tubing 71 and to the first aeration tube 28 and the second aeration tube 30.

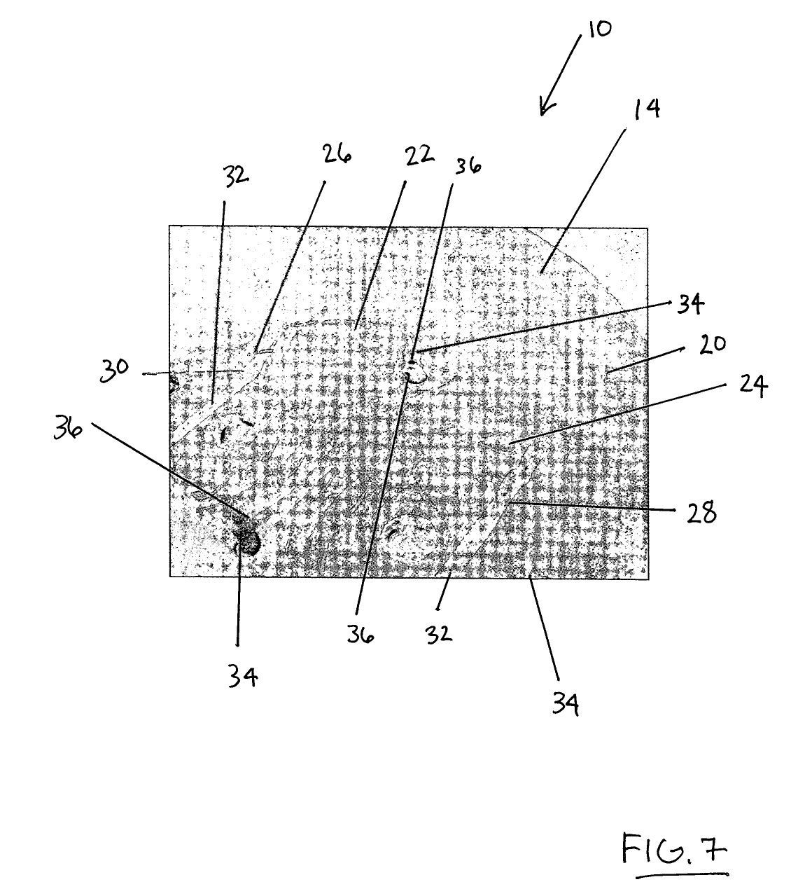

Referring to FIG. 7, the first aeration tube 28 and the second aeration tube 30 preferably emit bubbling air through the water in the reservoir 14 under the soles of the user for a period of time. In this manner, the first aeration tube 28 and the second aeration tube 30 massage with air the soles of the user's feet that are disposed on the first foot rest 24 and the second foot rest 26.

The foot bath 10 has a number of adjustable jets 34. Preferably, each of the number of adjustable jets 34 is substantially “L” shaped and is disposed through the bottom floor 22 as shown in a watertight manner. Alternatively, the adjustable jets 34 may be disposed in any suitable location in the housing 12 to create the first and the second whirling flow pattern. For example, the adjustable jets 34 may be alternatively disposed on the inner wall 20 or in any other suitable location on the bottom floor 22. Each adjustable jet 34 preferably has a small diameter opening or a nozzle 36. In this preferred embodiment, each adjustable jet 34 is at an edge of the foot bath 10 or at a location near an intersection on the bottom floor 22 and the inner wall 20.

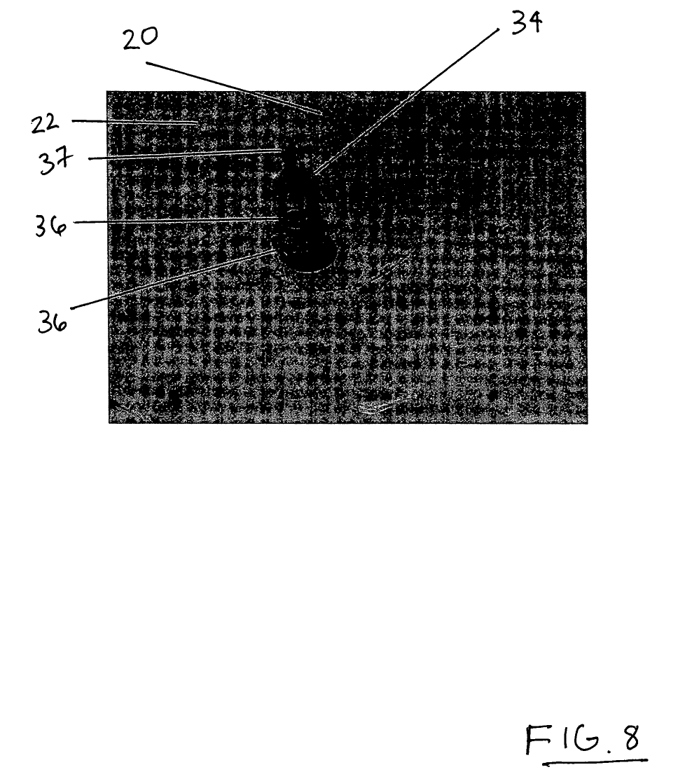

As is shown in FIG. 8, each adjustable jet 34 may have one or more nozzles 36. The one or more nozzles 36 provide for directing water in one or more directions from each adjustable jet 34. Each adjustable jet 34 forces a high-velocity water stream under pressure out of the nozzle 36 for circulating the water in the whirling flow pattern in the reservoir 14 in a counterclockwise or clockwise direction.

Each adjustable jet 34 may have a tab 37. The tab 37 is preferably an orthogonal shaped projection, flap, or short strip connected to the adjustable jet 34. Preferably, the tab 37 is connected to the top of the adjustable jet 34. However, one skilled in the art should appreciate that the tab 37 may be connected in any location on the adjustable jet 34 for manipulating the adjustable jet by an application of a force by the user. The tab 37 preferably facilitates rotating the adjustable jet 34 in one or more directions to allow the user to selectively change direction of the water escaping the nozzle 36.

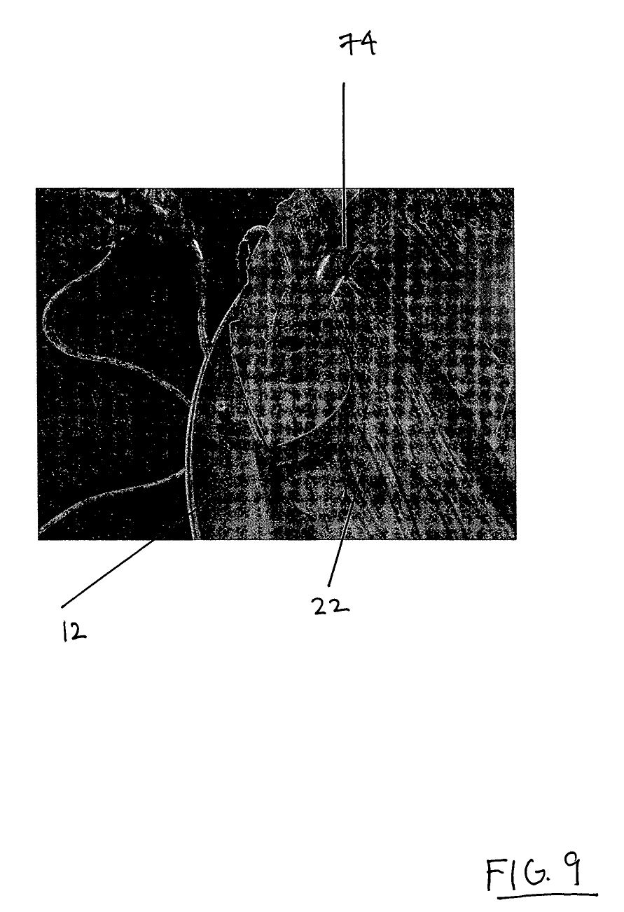

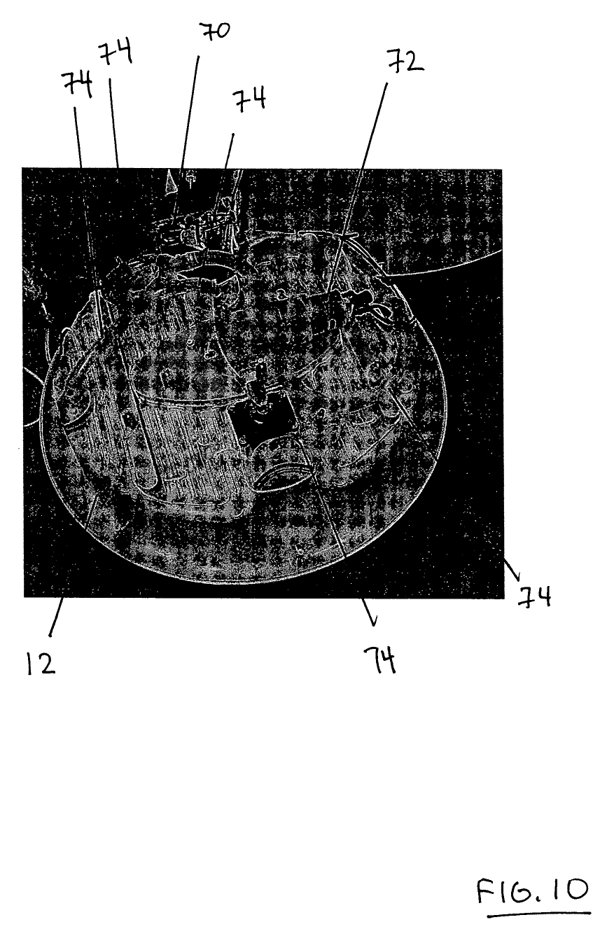

Referring to FIGS. 9 and 10, each adjustable jet 34 preferably is connected to a pump 72 in the housing 12 by a suitable tube 74.

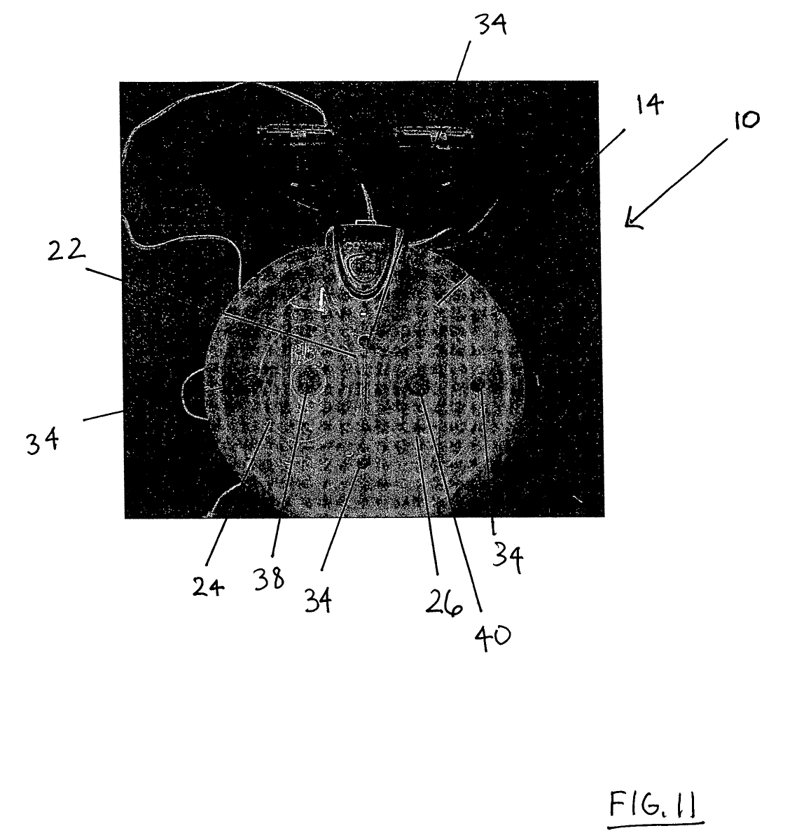

Referring to FIG. 11, the adjustable jets 34 are preferably in a radial array around an edge of the reservoir 14 of foot bath 10. Also, preferably, all of the adjustable jets 34 point in a clockwise or a counterclockwise direction. This arrangement preferably ensures that the first and the second whirling flow patterns are created. However, one skilled in the art should appreciate that the number of adjustable jets 34 may be disposed in any manner or orientation to ensure that the first and second whirling fluid flow patterns are created.

Preferably, the foot bath 10 has four adjustable jets 34 as shown. However, one skilled in the art should appreciate that the foot bath 10 may have any number of adjustable jets 34 to ensure that the first and second whirling flow patterns are created. Also each of the adjustable jets 34 may have any shape known in the art with any sized nozzle 36 for spraying water in the reservoir 14. Preferably, each adjustable jet 34 with the nozzle 36 sprays the water in a substantially horizontal manner parallel with the bottom floor 22.

However, the user may selectively adjust the direction of the spray of each adjustable jet 34, if the user desires a localized massaging action on, for example, a rear or lateral side of the treated foot. In a first aspect or embodiment of the present invention, the direction of each adjustable jet 34 may be changed either upwardly or downwardly relative to the bottom floor 22 by physically pushing or pulling each adjustable jet by the tab 37 upward or downward a desired amount. The direction may be further adjusted to spray water upward relative to the substantially horizontal manner or adjusted downward relative to the substantially horizontal manner, by pushing the adjustable jet 34 upward by the tab 37 or pulling the adjustable jet downward by the tab. Each adjustable jet 34 may further be selectively rotated from a clockwise position to a counterclockwise position to change a position of the spray pattern. The user may selectively twist each adjustable jet 34 in a counterclockwise or clockwise manner to further change a position of the spray pattern of the adjustable jet.

The foot bath 10 has a first drain 38 and a second drain 40. The first drain 38 is adjacent to the second drain 40. Preferably, the first drain 38 is disposed a distance away from the second drain 40. Preferably, the first drain 38 is about 6.25 inches away from the second drain 40. The first drain 38 and the second drain 40 are preferably an outlet of the reservoir 14 disposed on the bottom floor 22.

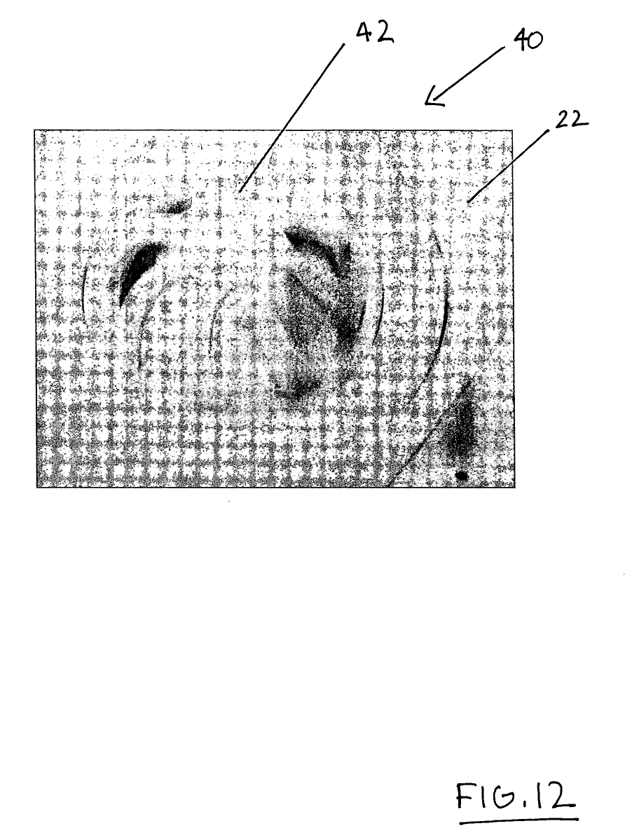

Referring to FIG. 12, each of the first and the second drains 38, 40 have a suitable grate 42 connected thereto. The grate 42 is connected over each of the respective first drain 38 and second drain 40. The grate 42 is preferably a convex shaped structure and extends outward an amount opposite from the bottom floor 22.

The grate 42 has framework of parallel or latticed bars for blocking an opening of each of the first and the second drains 38, 40. Preferably, the grate 42 is positioned in a comfortable location of both the first foot rest portion 24 and the second foot rest portion 26. Preferably, the grate 42 is located in the same location where an arch of the user's foot rests when on the bottom floor 22.

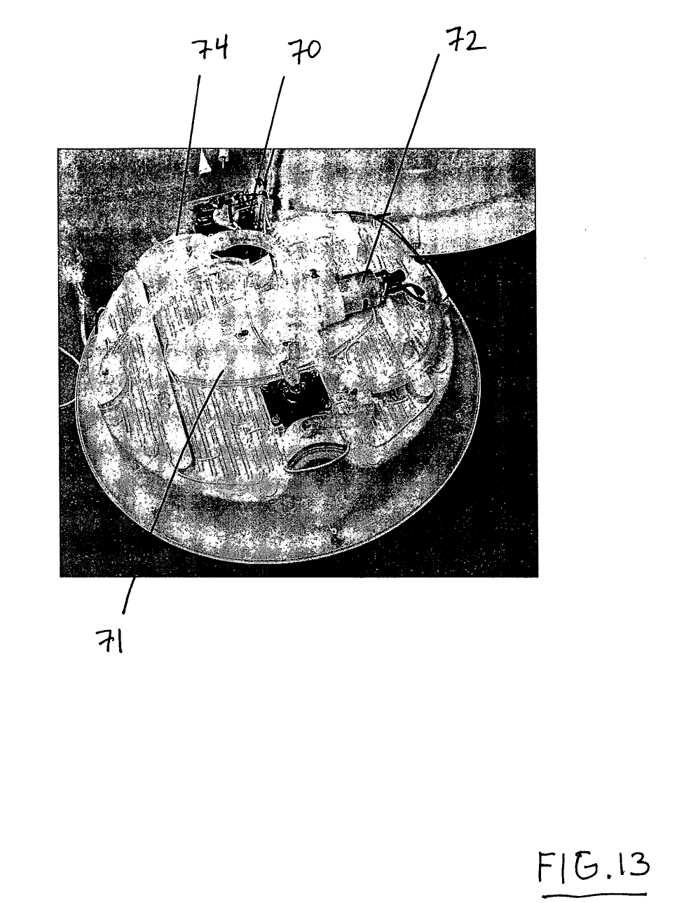

Referring to FIG. 13, each of the first drain 38 and the second drain 40 are disposed on an opposite side of the bottom floor 22 being generally represented by reference numeral 71. The first drain 38 and the second drain 40 are connected to the pump 72 under the reservoir 14. The pump 72 is preferably any mechanical device known in the art that moves the water from the first drain 38 and the second drain 40 to each adjustable jet 34 shown in FIG. 11, by pressure or suction through the tube 74. The pump 72 is preferably connected to each adjustable jet 34 underneath the opposite side 71 of the bottom floor 22 in a watertight manner. Thus, the water exiting the first drain 38 and the second drain 40 is pulled toward the pump 72 and circulated back to each adjustable jet 34 to introduce and spray the water in the reservoir 14 in the first and second whirling flow patterns.

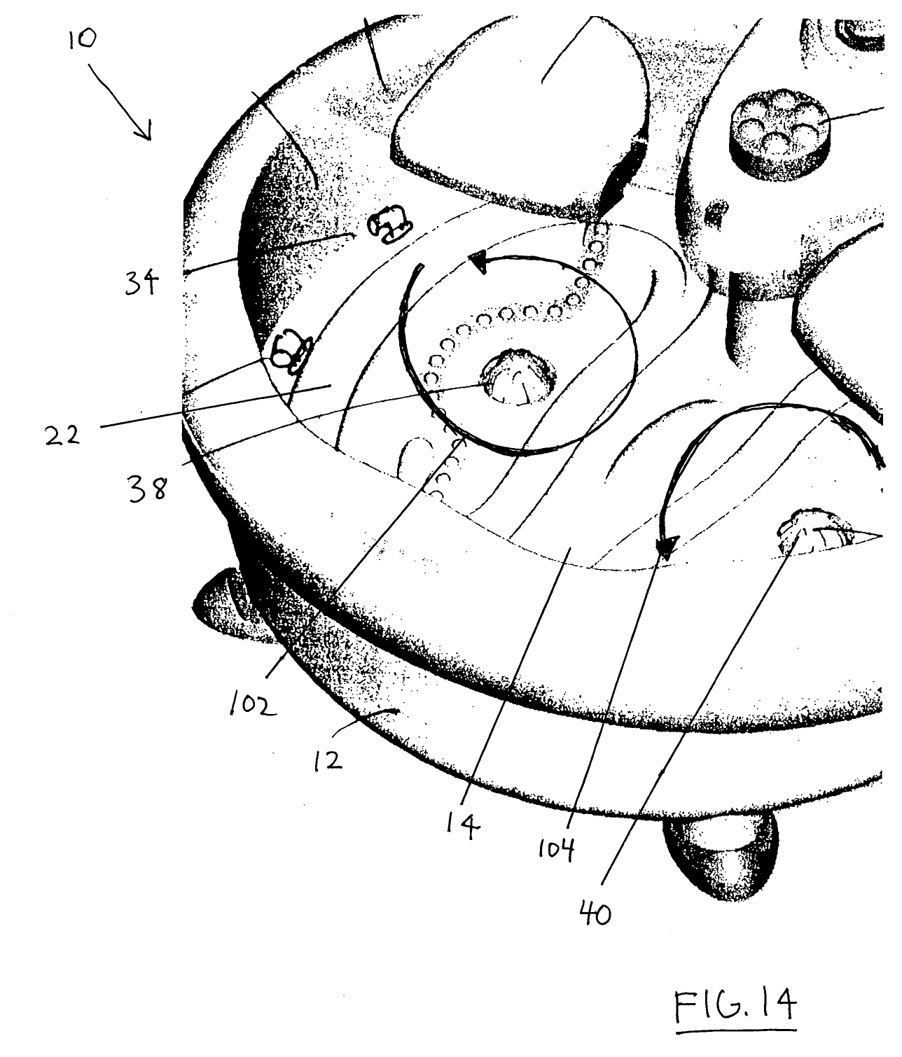

In one aspect or embodiment of the present invention shown in FIG. 14, the foot bath 10 has the adjustable jets 34 arranged to surround the first drain 38 and the second drain 40 and thus to circulate the water around each of the first drain and second drain. Most preferably, the water through the first drain 38 and the second drain 40 create the first whirling flow pattern and the second whirling flow pattern, respectively from the water in the reservoir 14 in a direction of reference arrows 102, 104, respectively.

Preferably, the first whirling flow pattern and the second whirling flow pattern are both a spiral motion of water in the reservoir 14. Preferably, the first drain 38 and the second drain 40 are at a substantially centermost portion of each of the spiral motions of the first whirling flow pattern and the second whirling flow pattern. Preferably, the first drain 38 and the second drain 40 draws all of the water near the center of the respective first and second whirling flow patterns to the pump 72 in the housing 12 underneath the bottom floor 22 shown in FIG. 13. Thus, the first and the second whirling flow patterns are created in the reservoir 14 for an aesthetically pleasing and relaxing foot massage. This ordered pattern is superior to the prior art chaotic shaking foot bath and that is distracting and aesthetically displeasing to the user.

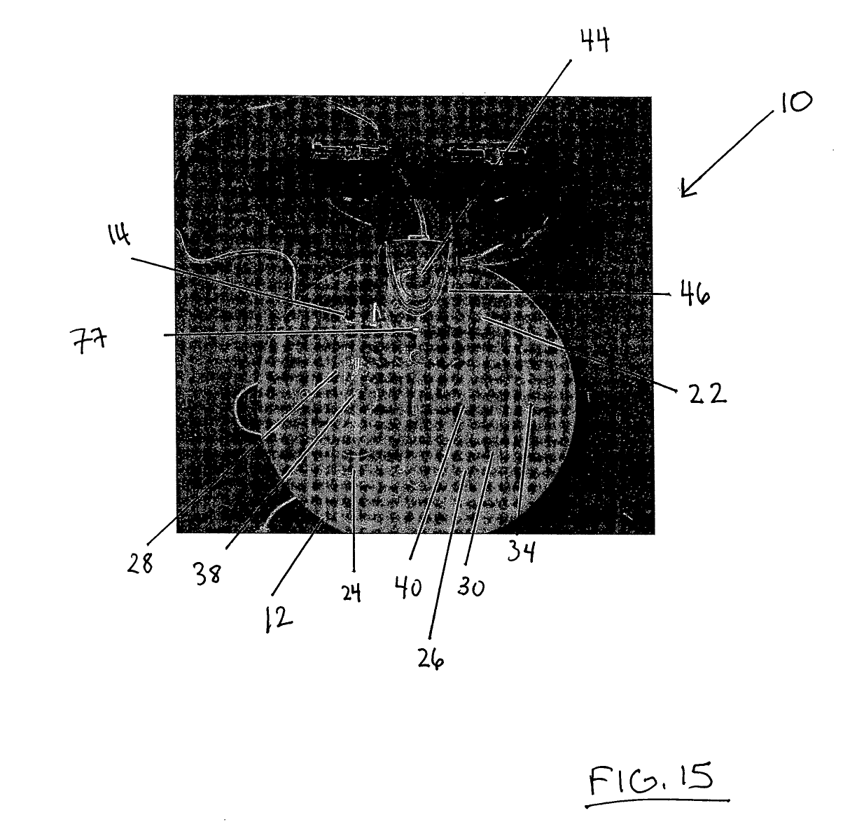

Referring to FIG. 15, the foot bath 10 has a controller or control button 44. The control button 44 is on a raised structure 46 of the housing 12. The control button 44 may alternatively be in any suitable location on the housing 12 for easy and comfortable access. Preferably, the control button 44 may be a waterproof button, a knob, an analog dial, a switch, or any number of buttons. The control button 44 may alternatively be digital controller or be any other controller with any configuration known in the art.

The control button 44 is adjustable, to various settings including, for example, “vibration on”, “vibration off”, “heat on”, “heat off”, “aeration on”, “aeration off”, “jets on” and “jets off”, or any combinations thereof, to activate or deactivate one or more features of the foot bath 10.

Alternatively, the foot bath 10 may have a receiver 77. The receiver 77 is preferably an infrared receiver or a radio frequency receiver for remote operation. Preferably, the receiver 77 may be disposed on a portion of the raised structure 46 of the foot bath 10 for communication with a suitable complementary remote control unit. In an alternative embodiment of the present invention, the remote control unit may be optionally tethered to the housing 12 to prevent misplacing the remote control unit.

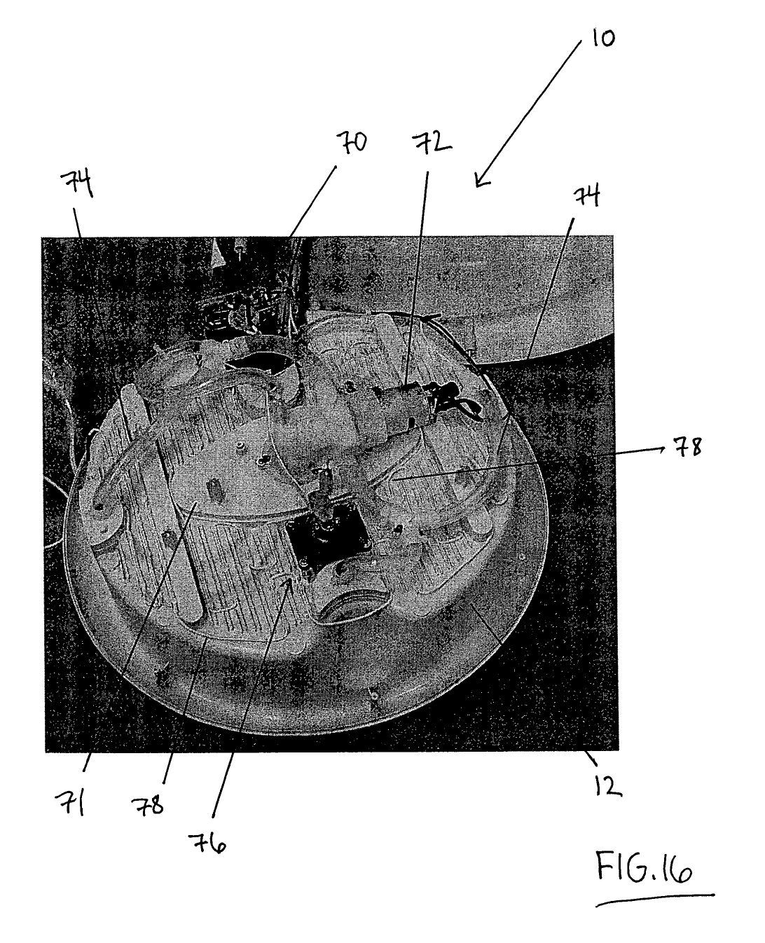

Referring to FIG. 16, the foot bath 10 has a vibration device 76 in the housing 12. The vibration device 76 preferably imparts a shaking or a limited reciprocating motion to shake the housing 12 and massage the user's feet. Preferably, the vibration device 76 is secured under the bottom floor 22 shown in FIG. 15 in the housing 12 under the reservoir 14. Preferably, the vibration device 76 shakes the first foot rest portion 24 and the second foot rest portion 26 shown in FIG. 15.

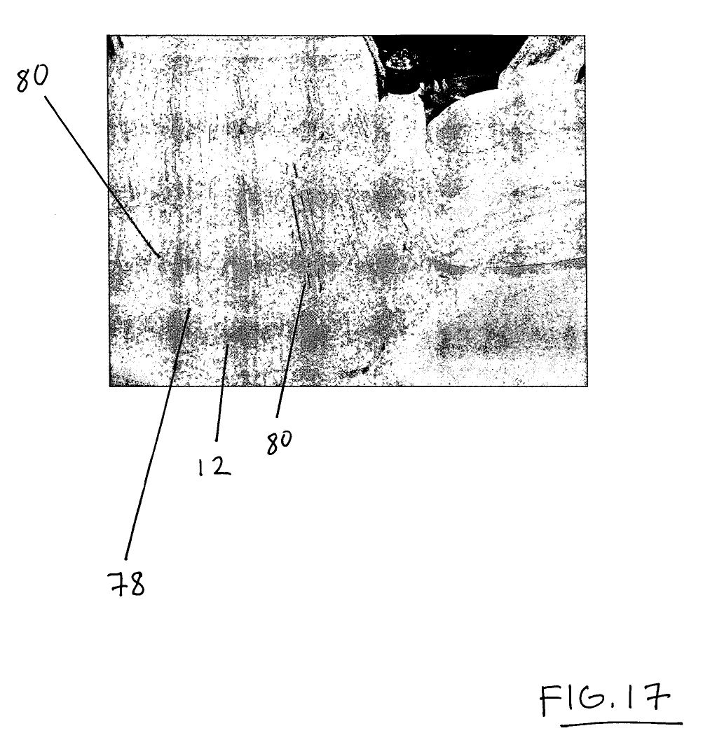

The foot bath 10 has a heater 78. The heater 78 is preferably a high electrical resistance heater wire that is connected to a power supply (not shown). Preferably, the power supply is external from the foot bath 10 and the foot bath is for use with a 120 volt circuit. Once actuated, the heater wire 78 preferably receives an electrical current from the power supply. The electrical current traversing through the heater wire 78 causes the heater wire to emit heat that preferably heats a portion of the user's feet or soles and the water in the reservoir 14. In one embodiment of the present invention shown in FIG. 17, the heater wire 78 is in a serpentine fashion in a channel 80 formed underneath the bottom floor 22 of the reservoir 14, preferably under the first foot rest portion 24 and the second foot rest portion 26.

Referring again to FIG. 1, the foot bath 10 also has a first pad 48 and a second pad 50. The first pad 48 and second pad 50 are both preferably a thin, cushion-like mass of soft material that is connected to the inner wall 20 or alternatively connected to a lid that is hinged to the reservoir 14 shown in FIG. 3. Preferably, the first pad 48 and the second pad 50 are removably connected to a lid being shown in FIG. 15. Less preferably, the first pad 48 and the second pad 50 may be directly connected to the bottom floor 22 or in any suitable location on the housing 12. The first pad 48 and the second pad 50 are disposed above the first and the second foot rest portions 24, 26. Preferably, the first and the second pads 48, 50 may be made from an absorbent material. In this manner, the first pad and the second pad 48, 50 dry the user's feet upon completion of the foot therapy when the user desires to exit the reservoir 14. Alternatively, the first pad 48 and the second pad 50 may be made from a gel to impart comfort or alternatively may be made from a dried loofa. The first pad 48 and the second pad 50 are used as a washing sponge to remove dead skin from the user's soles during foot therapy.

The foot bath also has a massaging attachment 52 also shown in FIG. 1. The massaging attachment 52 is a circular structure that has a number of convex protrusions 54 thereon. The massaging attachment 52, when actuated, preferably vibrates and rotates to massage the foot that is on the massaging attachment. In an embodiment of the present invention, depressing the massaging attachment, such as by a user's foot an amount preferably actuates the massaging attachment from an “on” to an “off” position or from “off” to an “on” position. This actuation of the massaging attachment 52 preferably vibrates the massaging attachment and also causes the massaging attachment to rotate for added foot therapy.

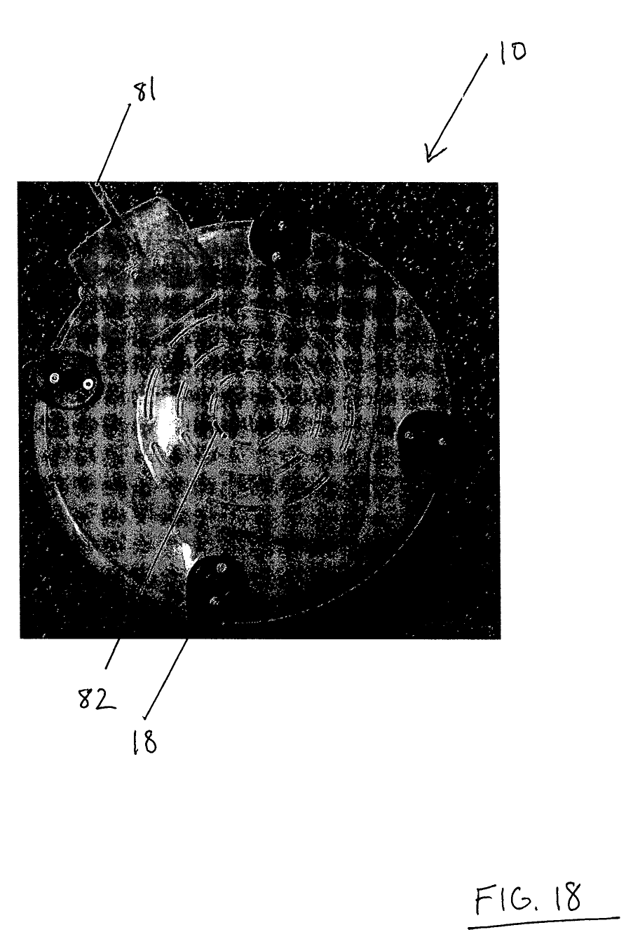

Referring to FIG. 18, the foot bath 10 preferably has four legs 18, a power cord 81 for linking the foot bath 10 to the power supply for household use and a number of vents 82. The number of vents 82 are arranged in a circular configuration and preferably draw an amount of fresh air therethrough for the aeration device 70 and to cool the pump 72, vibration device 76 and other components of the foot bath 10.

It should be understood that the foregoing description is only illustrative of the present invention. Various alternatives and modifications can be devised by those skilled in the art without departing from the invention. Accordingly, the present invention is intended to embrace all such alternatives, modifications and variances.

What is claimed is:

1. A portable foot bath comprising:
a reservoir for holding a volume of liquid having a floor;
a jet being disposed on said floor, said jet being connected to a pump;
a first outlet in a first location of said floor; and
a second outlet in a second location of said floor being at a different location than said first location, wherein said jet circulates the liquid in said reservoir, the liquid escaping through said first outlet and said second outlet creates a first whirling flow pattern and a second whirling flow pattern, respectively, from the liquid in said reservoir.

2. The portable foot bath of claim 1, wherein said jet is adjustable to control a direction of the liquid.

3. The portable foot bath of claim 1, wherein said jet has a plurality of nozzles.

4. The portable foot bath of claim 1, wherein said first outlet is a first drain located in said floor, said first drain having a grate.

5. The portable foot bath of claim 4, wherein said second outlet is a second drain located on said floor, said second drain having a grate.

6. The portable foot bath of claim 1, wherein said jet has a substantially “L” shape.

7. The portable foot bath of claim 1, wherein said first outlet is adjacent to said second outlet.

8. The portable foot bath of claim 1, wherein said jet is a plurality of jets disposed in a circular manner on said floor.

9. The portable foot bath of claim 1, wherein said jet sprays the liquid in a horizontal direction relative to said floor, said jet being adjustable to spray the liquid upward relative to said horizontal direction and adjustable to spray the liquid downward relative to said horizontal direction.

10. The portable foot bath of claim 1, further comprising a heater for heating the liquid in said reservoir.

11. The portable foot bath of claim 1, further comprising a vibratory device for imparting a plurality of vibrations to a user.

12. The portable foot bath of claim 1, further comprising a tube having a plurality of apertures disposed therein, said tube being disposed on or in said floor, said tubes releasing a plurality of gas bubbles through each of said plurality of apertures, said plurality of gas bubbles imparting a sensation to a user.

13. The portable foot bath of claim 1, wherein said jet is connected to said first outlet and said second outlet, said first outlet and said second outlet providing the liquid to said pump, said pump circulating the liquid to said jet, said jet spraying the liquid in said reservoir in said first whirling flow pattern and said second whirling flow pattern in a continuous manner.

14. A portable foot bath comprising:
a housing having a plurality of legs and a substantially circular shaped reservoir formed therein, said substantially circular shaped reservoir holding a volume of water, said circular shaped reservoir having a floor;
a plurality of adjustable jets, each of said plurality of adjustable jets having a substantially “L” shape, said plurality of adjustable jets being in said housing in a substantially circular array, each of said plurality of jets having an inlet and an outlet, each inlet being connected to a pump, each outlet being a nozzle for releasing a pressurized flow of said water in said reservoir; and
a plurality of outlets being disposed through said floor connected to said pump, wherein said water escapes through said plurality of outlets and creates a plurality of whirling flow patterns in said substantially circular shaped reservoir when said plurality of adjustable jets circulate said water in said reservoir.

15. The portable foot bath of claim 14, wherein said plurality of whirling flow patterns is each a pattern of a swirl.

16. The portable foot bath of claim 14, said plurality of whirling flow patterns are each a whirling mass of water, said whirling mass being drawn to a centermost portion of each of said plurality of outlets.

17. The portable foot bath of claim 14, wherein each of said plurality of adjustable jets has a substantially “L” shape.

18. The portable foot bath of claim 14, further comprising a first and a second foot rests, said first and said second foot rests being disposed on said floor, at least one of said plurality of outlets being disposed in each of said first and said second foot rests, at least one of said plurality of outlet having a grate being disposed thereon, said grate having a convex shape.

19. The portable foot bath of claim 14, wherein each of said plurality of adjustable jets sprays said water in a horizontal direction and is adjustable to spray said water in a first direction being inclined from said horizontal direction and in a second direction being declined from said horizontal direction.

20. The portable foot bath of claim 14, wherein each of said plurality of whirling flow patterns in said substantially circular shaped reservoir has a direction, said direction being selected from the group consisting of a clockwise direction, a counterclockwise direction, and any combinations thereof.

21. A portable foot bath for massaging a foot comprising:
a reservoir having a floor;
a pump;
a jet connected to said pump;
a first outlet in a first location of said floor; and
a second outlet in a second location of said floor, said second location being a different location than said first location, wherein said first outlet and said second outlet each have a grate connected thereto, said grate having a convex shape, said convex shape preventing any blockage of said first outlet and said second outlet by the foot.
